(19) United States
(12) Patent Application Publication
(10) Pub. No.: US 2019/0286710 A1
(43) Pub. Date: Sep. 19, 2019

(54) MARITIME RADIO COMMUNICATION METHOD USING ENCODED STANDARD MARITIME COMMUNICATION PHRASES

(71) Applicant: Mokpo National Maritime University Industry-Academic Cooperation Foundation, Mokpo-si (KR)

(72) Inventors: JaeYong JEONG, Jeollanam-do (KR); JeongBin YIM, Busan (KR); Heejin LEE, Muan-gun, Jeollanam-do (KR)

(73) Assignee: Mokpo National Maritime University Industry-Academic Cooperation Foundation, Mokpo-si (KR)

(21) Appl. No.: 16/003,086

(22) Filed: Jun. 7, 2018

(30) Foreign Application Priority Data
Mar. 14, 2018 (KR) 10-2018-0029529

(51) Int. Cl. G06F 17/28; H04B 7/26; G10L 15/22; G10L 15/08

(52) U.S. Cl. CPC G06F 17/2836; H04B 7/26; G10L 2015/088; G10L 15/08; G10L 15/22

(57) ABSTRACT

The present invention relates to a maritime radio communication technology and, most particularly, to a maritime radio communication method using encoded standard maritime communication phrases capable of supporting text communication that can be exchanged between ships (or vessels) by encoding the standard maritime communication phrases (SMCP). As a method of performing communication through a channel of a Very High Frequency (VHF) band between an own ship and a target ship, provided herein is a maritime radio communication method using encoded standard maritime communication phrases (SMCP) including a search step searching encoded phrases of the standard maritime communication phrases (SMCP) including an inputted keyword, an output step outputting the encoded phrases including the keyword in accordance with respective priority levels based on the search result, and, as one phrase among the outputted encoded phrases is selected, a transmission step transmitting the selected encoded phrase to the target ship.

This application claims the benefit of the Korean Patent Application No. 10-2018-0029529, filed on Mar. 14, 2018, which is hereby incorporated by reference as if fully set forth herein.

### BACKGROUND OF THE INVENTION

### Field of the Invention

The present invention relates to a maritime radio communication technology and, most particularly, to a maritime radio communication method using encoded standard maritime communication phrases capable of supporting text communication that can be exchanged between ships (or vessels) by encoding the standard maritime communication phrases (SMCP).

### Discussion of the Related Art

One of the most important functions of maritime (or marine) radio communication corresponds to the function of identification (or recognition), tracking, surveillance for the safety and security of ships (or vessels), and the maritime radio communication provides services for exchanging (or sharing) information between ships (or ship-to-ship information exchange services). For this, the current maritime radio communication provides radio communication services through a Very High Frequency (VHF) band and a Medium Frequency (MF)/High Frequency (HF) band and maritime communication services using a Maritime Very Small Aperture Terminal (MVSAT).

The maritime radio communication using the VHF band is currently used by adopting an Automatic Identification System (AIS), and an object of the maritime radio communication using the VHF band is to ensure maritime traffic security in coastal areas and to support vessel traffic services in ports as well as to support search and rescue operations of ships (or vessels) in distress, by receiving and processing navigation-related information, such as sailing position, course, speed, and so on, which is automatically transmitted from a ship that is currently at sea, and, then, by relaying the processed information to other ships. The AIS, which is used for the above-described purpose, operates in the VHF band based on a Self-Organized TDMA (SOTDMA) scheme. A VHF communication equipment selects a channel from a selection of multiple channels and establishes communication with another ship (or target ship) or the shore that uses the same channel. Generally, all ships are required to set up Channel 16, which is an international calling and distress channel, in order to be capable of communicating with other ships at sea or the shore.

The MF/HF band is used for long distance data transmission that is more extended than the transmission distance of the VHF band. Presently, the HF band modem uses a Frequency Shift Keying (FSK) scheme, and, in case the maximum transmission distance is exceeded, the HF band modem supports a service allowing the base station of other countries to be used. The HF band modem mostly corresponds to an equipment that can directly call other ships when in distress or in an emergency situation.

The MVSAT corresponds to a next generation ultra-fast satellite communication system specified for marine vessels (or ships) that can replace the. International Maritime Satellite (INMARSAT), which corresponds to a main communication equipment capable of exchanging navigation-related information (i.e., weather, navigation information, etc.) through ship-to-ship and/or ship-to-shore communication via satellite in the conventional ship (or marine vessel) communication. The MVSAT may provide communication services at a maximum transmission speed (or rate) that is equivalent to the ultra-fast communication speed provided on land. Thus, the crew and/or passengers may be provided with internet services on board of the ship (or marine vessel) as excellent as the internet services provided on land.

In the above-described marine communication technology, most of the real-time communication that is performed for entry and departure reports and for avoiding collision between marine vessels is performed via VHF. When one ship (hereinafter referred to as “own ship”) attempts to perform a first communication session with another ship (hereinafter referred to as “target ship”), the ship is only capable of making the call by using the VHF Channel 16. However, when a ship attempts to perform communication in a situation where an excessive number of ships are at sea, this causes a considerable amount of interference and cross-talk resulting from the massive amount of traffic, the own ship has difficulty in understanding and/or conveying the information it wishes to exchange.

Most particularly, since English is mostly used when performing ship-to-ship communication, the range of variations (or differences) for each country in pronouncing spoken English is broad. Accordingly, due to such variations for each country in pronouncing spoken English, ship operators (or marine technicians) experience many difficulties in clearly and accurately understanding the content of their communication. Also, in some cases, due to the limitations in translating expressions used in a specific country to English, problems conveying (or sending out) unintended messages occasionally occurred during communication.

### SUMMARY OF THE INVENTION

An object of the present invention has been devised in consideration of the above-described problems, and, most particularly, an object of the present invention is to provide a maritime radio communication method using encoded standard maritime communication phrases (SMCP) capable of supporting text communication that can be exchanged between ships (or vessels) by encoding the standard maritime communication phrases (SMCP).

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve the above-described technical object, as a method of performing communication through a channel of a Very High Frequency (VHF) band between an own ship and a target ship, provided herein is a maritime radio communication method using encoded standard maritime communication phrases (SMCP) including a search step searching encoded phrases of the standard maritime communication phrases (SMCP) including an inputted keyword, an output step outputting the encoded phrases including the keyword in accordance with respective priority levels based on the search result, and, as one phrase among the outputted encoded phrases is selected, a transmission step transmitting the selected encoded phrase to the target ship.

Preferably, the keyword may be inputted by voice through a microphone or inputted by text through a keyboard.

Preferably, a voice inputted through a microphone or a text inputted through a keyboard may be inputted after being converted (or translated) to a language supported by the standard maritime communication phrases (SMCP).

Preferably, a plurality of phrases of the standard maritime communication phrases (SMCP) including the keyword may be selected, and each of the selected phrases may be encoded so as to generate the encoded phrases.

More preferably, each of the encoded phrases may be assigned with a different priority level and stored in a database.

More preferably, priority levels being assigned to the encoded phrases may be determined in accordance with a frequency in use of the encoded phrases, and the frequency of use of the encoded phrases is updated in accordance with a number of transmissions performed in the transmission step, thereby varying the priority levels of the encoded phrases.

More preferably, priority levels being assigned to the encoded phrases may be determined in accordance with a predetermined level of importance of the encoded phrases.

More preferably, in the output step, the priority levels being determined in accordance with the frequency in use or the level of importance may be varied based on a speed and steering of the own ship, and the encoded phrases are outputted in accordance with the varied priority levels.

Preferably, before the transmission step, the method may further include a step of converting the selected encoded phrase to a language supported by the standard maritime communication phrases (SMCP).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a flow chart for describing a maritime radio communication procedure using encoded standard maritime communication phrases (SMCP) according to an exemplary embodiment of the present invention.

FIG. 2 illustrates a flow chart for describing a more detailed procedure for performing maritime radio communication using encoded standard maritime communication phrases (SMCP) according to an exemplary embodiment of the present invention.

### DETAILED DESCRIPTION OF THE INVENTION

Other objects, characteristics, and advantages of the present invention will be apparent based on the detailed description of the exemplary embodiment of the present invention, which will hereinafter be presented with reference to the accompanying drawings.

Hereinafter, the structure and operation of the exemplary embodiment of the present invention will be described in detail with reference to the accompanying drawings, and the description of the structure and operation of the present invention will be presented according to at least one exemplary embodiment of the present invention. And, therefore, the technical scope and spirit of the present invention and its essential structure and operation will not be limited only to the description of the exemplary embodiment presented herein.

Hereinafter, a preferred exemplary embodiment of the maritime radio communication method using encoded standard maritime communication phrases will be described in detail.

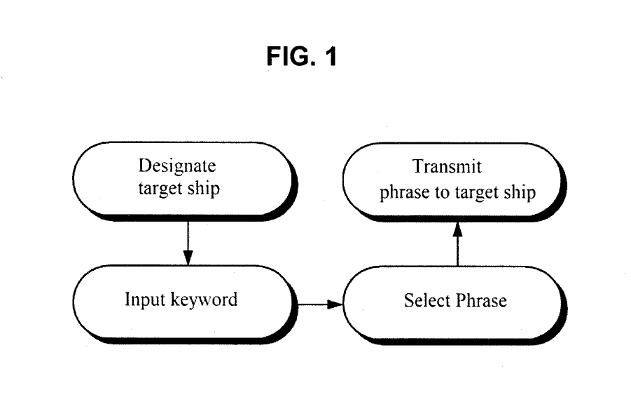

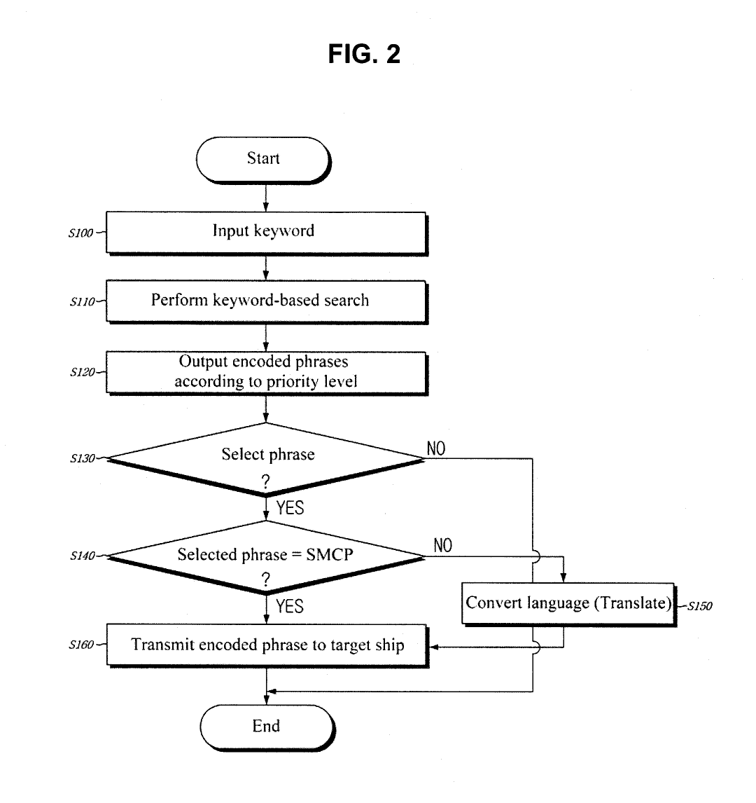

FIG. 1 illustrates a flow chart for describing a maritime radio communication procedure using encoded standard maritime communication phrases (SMCP) according to an exemplary embodiment of the present invention. And, FIG. 2 illustrates a flow chart for describing a more detailed procedure for performing maritime radio communication using encoded standard maritime communication phrases (SMCP) according to an exemplary embodiment of the present invention.

Referring to FIG. 1 and FIG. 2, the present invention describes a method for performing communication between an own ship and a target ship through a Very High Frequency (VHF) band channel. However, in the present invention, the band will not be limited only to the VHF band, and, therefore, the present invention may also be easily applied to radio communication services using Medium Frequency (MF)/High Frequency (HF) bands.

In the radio communication procedure according to the present invention, the own ship first selects a target ship it wishes to communicate with. At this point, the own ship uses VHF Channel 16 to call the target ship and waits for the communication to be established with the target ship through the corresponding Channel 16.

Thereafter, a ship operator of the own ship inputs a keyword and, then, selects one of a plurality of encoded standard maritime communication phrases (SMCP) that are searched by using the inputted keyword.

Subsequently, the own ship transmits the selected encoded phrase to the target ship.

For example, while listening to Channel 16, if the ship operator inputs the keyword “alter course starboard” using his/her voice or a keyboard, encoded phrases (or sentences) including the corresponding keyword are outputted as listed below.

1. This ship will alter course starboard

2. Will your ship alter course starboard?

3. This ship will alter course starboard and pass through from the rear end

If encoded phrase number 1 is selected among the outputted encoded phrases, the selected encoded phrase is converted (or translated) to the language supported by standard maritime communication phrase (SMCP) as shown below.

1. I will alter course to STBD side

Thereafter, when a transmission of the selected encoded phrase is requested, the own ship transmits the corresponding phrase to the target ship.

Referring to FIG. 2, the corresponding radio communication procedure using the encoded standard maritime communication phrase according to the present invention will be described in detail.

The ship operator may input a wanted keyword. The keyword may be inputted by voice through a microphone or may be inputted by text through a keyboard.

Meanwhile, in the present invention, the voice being inputted through a microphone or the text being inputted through a keyboard may be converted (or translated) into the language, which is supported by the standard maritime communication phrases, and may then be inputted.

When a keyword is inputted (S100), a search that is based on the inputted keyword is performed (S110).

More specifically, encoded phrases of the standard maritime communication phrases (SMCP) including the inputted keyword are searched.

Thereafter, based on the search results, the encoded phrases including the keyword may be outputted based on the respective priority levels of the searched encoded phrases.

Most particularly, if the inputted keyword corresponds to the language spoken in the own ship's country (or the spoken language of the own ship's nationality) instead of the standard marine communication phrases (SMCP), it is preferable that the encoded phrases including the inputted keyword are also configured in the spoken language of the own ship's country.

Accordingly, a system supporting the present invention may store in advance the encoded phrases configured in the spoken language of the own ship's country in its database.

Meanwhile, when generating the encoded phrases (or sentences) including the inputted keyword, the encoded phrases may be generated by selecting a plurality of phrases among the standard maritime communication phrases (SMCP) including the encoded phrases and by encoding each of the selected phrases. Since a plurality of phrases are selected from the standard maritime communication phrases (SMCP), the selected phrases of the standard maritime communication phrases (SMCP) may undergo a process of being converted (or translated) to the spoken language of the own ship's country.

The encoded phrases, which are generated as described above, may be stored in the database at different priority levels. Herein, the priority levels may be determined in accordance with frequency of use and level of importance. However, in case of determining the priority levels based on the frequency of use, since the frequency of use may be updated, the priority levels may also vary accordingly.

For example, the priority levels being assigned to the encoded phrases (or sentences) may be determined in accordance with the frequency of use of the encoded phrases, and the priority levels of the encoded phrases may be varied by updating the frequency of use of the encoded phrases in accordance with a number of transmissions of the encoded phrases.

As another example, the priority levels being assigned to the encoded phrases may be determined in accordance with a predetermined level of importance respective to each of the encoded phrases.

As yet another example, when outputting the encoded phrases in accordance with keyword-based search results (or search results searched based on the keyword), the priority levels that are determined in accordance with the frequency of use or the level of importance may be varied in accordance with a speed and steering of the own ship. And, then, the phrases that are encoded in accordance with the varied priority levels may be outputted. This may be understood that the level of importance of the encoded phrases is varied in accordance with a status of the navigation course according to the operating condition of the own ship.

In the present invention, in case the inputted keyword or the search result searched based on the keyword corresponds to a language that is supported by the standard maritime communication phrases (SMCP), when the ship operator selects one of the outputted encoded phrases (S130), the ship operator then immediately transmits the encoded phrases to the target ship (160).

However, in the present invention, as preparation for a case where the keyword or the search result searched based on the keyword corresponds to the language spoken in the own ship's country instead of the standard maritime communication phrases (SMCP), as the ship operator selects one of the outputted encoded phrases, after verifying whether or not the selected encoded phrase corresponds to one of the standard maritime communication phrases (SMCP), the ship operator transmits the selected encoded phrase to the target ship.

More specifically, when the ship operator selects one of the outputted encoded phrases (S130), the ship operator verifies whether or not the selected encoded phrase corresponds to a standard maritime communication phrase (S140). If the selected encoded phrase corresponds to a standard maritime communication phrase, the ship operator immediately transmits the corresponding encoded phrase to the target ship (160). However, if the selected encoded phrase does not correspond to a standard maritime communication phrase, prior to transmitting the selected encoded phrase, the ship operator converts (or translates) the selected encoded phrase to the language supported by the standard maritime communication phrases (SMCP) and then transmits the converted (or translated) phrase to the target ship (160).

As described above, the maritime radio communication method using encoded standard maritime communication phrases has the following advantages.

According to the present invention, by encoding the standard maritime communication phrases (SMCP) and supporting text communication that can be exchanged between ships (or vessels), a more correct and faster communication with other ships can be performed.

Most particularly, by being capable of overcoming the diverse variations of each country in pronouncing spoken English, the contents (or messages) of communication may be clearly and accurately conveyed and understood.

Although the present invention has been described according to the preferred exemplary embodiment of the present invention, it will be apparent to those skilled in the art that various modifications and variations can be made in this specification without departing from the spirit or scope of this specification.

Thus, it is intended that this specification covers the modifications and variations of this invention provided they come within the scope of the appended claims and their equivalents. It is also apparent that such variations of this specification are not to be understood individually or separately from the technical scope or spirit of this specification, and all differences lying within the scope of the appended claims and their equivalents should be interpreted as being included in the present invention.

What is claimed is:

1. As a method of performing communication through a channel of a Very High Frequency (VHF) band between an own ship and a target ship, a maritime radio communication method using encoded standard maritime communication phrases (SMCP), comprising:
a search step searching encoded phrases of the standard maritime communication phrases (SMCP) including an inputted keyword;
an output step outputting the encoded phrases including the keyword in accordance with respective priority levels based on the search result; and
as one phrase among the outputted encoded phrases is selected, a transmission step transmitting the selected encoded phrase to the target ship.

2. The method of claim 1, wherein the keyword is inputted by voice through a microphone or inputted by text through a keyboard.

3. The method of claim 1, wherein a voice inputted through a microphone or a text inputted through a keyboard is inputted after being converted (or translated) to a language supported by the standard maritime communication phrases (SMCP).

4. The method of claim 1, wherein a plurality of phrases of the standard maritime communication phrases (SMCP) including the keyword are selected, and each of the selected phrases are encoded so as to generate the encoded phrases.

5. The method of claim 4, wherein each of the encoded phrases is assigned with a different priority level and stored in a database.

6. The method of claim 5, priority levels being assigned to the encoded phrases are determined in accordance with a frequency in use of the encoded phrases.

7. The method of claim 6, wherein the frequency of use of the encoded phrases is updated in accordance with a number of transmissions performed in the transmission step, thereby varying the priority levels of the encoded phrases.

8. The method of claim 5, priority levels being assigned to the encoded phrases are determined in accordance with a predetermined level of importance of the encoded phrases.

9. The method of claim 6, wherein, in the output step, the priority levels being determined in accordance with the frequency in use or the level of importance are varied based on a speed and steering of the own ship, and the encoded phrases are outputted in accordance with the varied priority levels.

10. The method of claim 7, wherein, in the output step, the priority levels being determined in accordance with the frequency in use or the level of importance are varied based on a speed and steering of the own ship, and the encoded phrases are outputted in accordance with the varied priority levels.

11. The method of claim 8, wherein, in the output step, the priority levels being determined in accordance with the frequency in use or the level of importance are varied based on a speed and steering of the own ship, and the encoded phrases are outputted in accordance with the varied priority levels.

12. The method of claim 1, further comprising:
before the transmission step, a step of converting the selected encoded phrase to a language supported by the standard maritime communication phrases (SMCP).
